(19) United States
(12) Patent Application Publication
(10) Pub. No.: US 2006/0014847 A1
(43) Pub. Date: Jan. 19, 2006

(54) Infrared curable ink compositions

(76) Inventors: Eytan Cohen, Ra'anana (IL); Michael Kheyfets, Jerusalem (IL)

Correspondence Address: PEARL COHEN ZEDEK, LLP, 10 ROCKEFELLER PLAZA, SUITE 1001, NEW YORK, NY, 10020, US

(21) Appl. No.: 11/231,999

(22) Filed: Sep. 22, 2005

Related U.S. Application Data
(62) Division of application No. 10/694,876, filed on Oct. 29, 2003.
(60) Provisional application No. 60/421,832, filed on Oct. 29, 2002.

(51) Int. Cl. C08B 37/00

(52) U.S. Cl. 522/7

(57) ABSTRACT

Infrared curable ink compositions are provided. The ink composition comprises an acrylate and an infrared activated initiator. The infrared activated initiator may be lauroyl peroxide, dicumyl peroxide, pentanedione-peroxide, tert-amyl peroxy-benzoate, 1,1′-azobis-cyclohexane carbonitryle or any combination thereof.

### CROSS-REFERENCE TO RELATED APPLICATIONS

The present application is a divisional application of U.S. patent application Ser. No. 10/694,876, filed on Oct. 29, 2003, which in turn takes priority from U.S. provisional application Ser. No. 60/421,832, filed Oct. 29, 2002.

### BACKGROUND OF THE INVENTION

Inks used in the ink-jet printing industry are typically liquid solutions or emulsions. Known types of ink are oil-based inks, non-aqueous solvent-based inks, water-based inks, and solid inks. The ink-jet printing process involves jetting droplets of ink from orifices of a print head onto a print medium. Then, the deposited ink droplets are dried. Heat is often used to accelerate the drying process. The drying of water-based ink usually requires significant amounts of energy. Solvent-based inks emit volatile organic compounds and are environmental hazard.

Recently, curing of ink by radiation, and in particular ultraviolet (UV) curing has become popular. In these cases, special radiation-curable ink is used and the image is cured by exposure to a radiation source. The term “curing” in the context of the present application refers to a process of converting a liquid, such as ink into a solid by exposure to actinic radiation. The use of radiation-curable inks and the curing process are rapidly becoming an alternative to the established conventional drying process.

The UV curing technology is not free, however of drawbacks. UV curable inks may be harmful to the operator. High power levels are required to generate sufficient UV curing energy, however, most of the energy generated is heat. The heat heats-up the medium and may cause warping and also limits the selection of possible substrates. Excessive heat may affects also the print head and additional cooling systems are not always helpful.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a simplified block-diagram illustration of an inkjet printing and curing system operation helpful in understanding an exemplary embodiment of the present invention;

FIG. 2 is a simplified illustration of a print head and a curing system according to some embodiments of the present invention;

FIG. 3 is an illustration of the interaction between a radiation spot and an ink droplet according to some embodiments of the present invention;

FIG. 4 is an illustration of an ultraviolet lamp arrangement for curing ink according to some embodiments of the present invention; and

FIG. 5 is a flowchart diagram of a method of curing ink according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, formulation and compositions have not been described in detail so as not to obscure the present invention.

Some embodiments of the present invention are directed to curing of a marking material, such as ink based on the content of the printed image. The term “curing” throughout the specification and the claims refers to the process of converting a liquid, such as, for example ink to a solid by exposing it to an actinic radiation, such as ultraviolet radiation. According to some embodiments of the present invention the curing radiation is an infrared radiation and the ink used for printing is infrared curable ink containing infrared activated initiators.

According to some embodiments of the present invention the amount of the radiation energy that may be required to cure the ink droplets that form a portion of a printed image is related to the image content. Accordingly, the amount of heat generated during the curing process may be reduced significantly in comparison to existing curing methods.

The term “image content”, throughout the specification and the claims, refers to the colors of the inks and to the ink coverage. For example, ink coverage of 187% may comprise 40% cyan ink, 55% magenta ink, 70% yellow ink and 22% black ink. Also, the term “image content” may, in addition, refers to the thickness of the ink layer, for example, a single color ink layer or a multiple-color layer

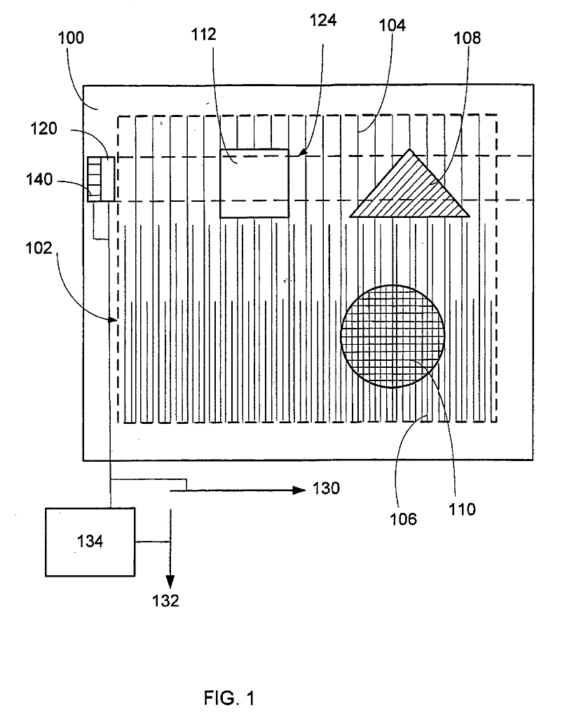

FIG. 1 is a simplified illustration of an inkjet printing and curing system operation helpful in understanding an exemplary embodiment of the present invention. It shows a substrate 100 having an image background 102. Image 102 varies in its image content. For example, area 104 of image 102 is lighter than area 106. Substrate 100 further comprises portions 108 and 110 having different image content. For example, portion 108 may have 40% ink coverage and portion 110 may have 220% ink coverage. Substrate 100 further comprises a portion 112, which does not contain image.

In the description below, the example of an inkjet application is given, however embodiments of the present invention may be equally applicable to other printing applications, such as, for example electro-photography application where different amounts of energy may be required to cure different amounts of toner.

The system illustrated in FIG. 1 may comprise a multi nozzle inkjet print head 120, a controller 134 and a radiation unit 140, such as an array of laser diodes. During printing, print head 120 may move in a direction indicated by arrow 130 and may eject ink droplets to cover a strip 124 on substrate 100 according to the image data. Radiation unit 140 may move together with print head 100 and may cure the ink droplets deposited onto strip 124 as described hereinbelow. Alternatively, the laser diodes may be coupled to optical fibers and may not move together with the print head.

Radiation unit 140 may be a single laser radiation source, such as infrared laser diode with a scanning arrangement, such as a scanning mirror, an array of laser diodes, an ultraviolet lamp and an array of multiple ultraviolet lamps.

Controller 134 may control the operation of inkjet print head 120 and radiation unit 140, and the movement of substrate 100 in a direction indicated by arrow 132.

As print head 120 ejects different amount of droplets to print different portions of strip 124, controller 134 may activate or deactivate radiation unit 140. Radiation unit 140 according to some embodiments of the present invention is operable to deliver different amounts of energy to different portions of the image deposited onto substrate 100 according to the instructions provided by controller 134. Based on the raster image processing (RIP) information, controller 134 may determine the amount of energy to required to cure different portions of the image deposited onto substrate 100.

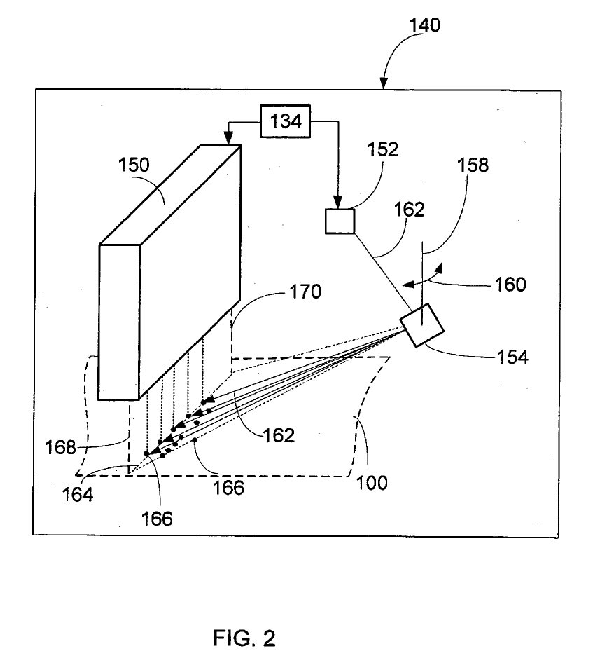

FIG. 2 is a simplified illustration of a print head and a curing system having a single laser radiation source and a scanning mechanism according to some embodiments of the present invention.

An inkjet printing system 145 may comprise an inkjet print head 150, a laser diode 152 and a scanning mirror 154. Print head 150 may be, for example, but not limited to, print head XAAR XJ500, commercially available from XAAR, Cambridge, England. Laser diode 152 may be for example but not limited to a laser diode from the SDL 6370 series, commercially available from JDS Uniphase Inc., Mountain View, Calif., USA. The laser beam focusing optics (not shown) may be part of the laser diode unit or alternatively may be a separate unit. Scanning mirror 154 may vibrate around axis 158 as indicated by arrow 160. Scanning mirror 154 scans a laser beam 162 along line 164, which represents a row of pixels 166. The distance between dashed lines 168 and 170 indicates the distance between the two marginal nozzles of print head 150. The length of the scanning path of the laser beam is set accordingly.

Controller 134 may activate laser diode 152 when the position of the laser beam 162 coincides with positions 166 of deposited ink droplets. In accordance with the exemplary embodiment, the size of the scanning laser spot may be the size of a single ink droplet (pixel) or larger. Laser beam 162 may be directed to the center of deposited droplet 166.

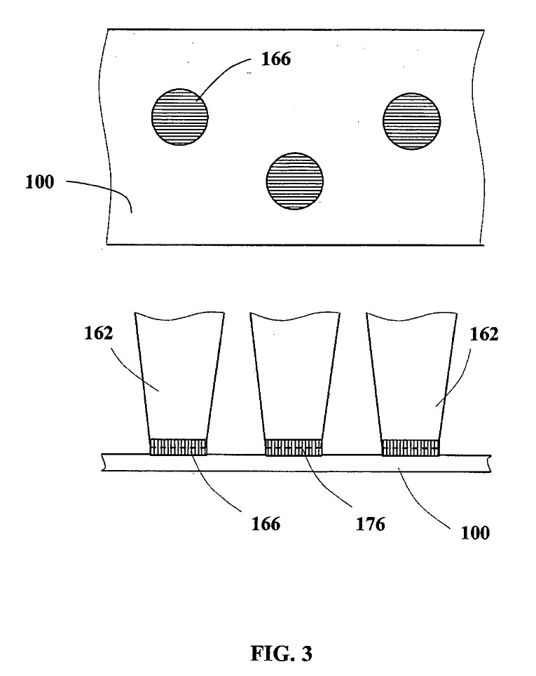

FIG. 3 shows a top view and an elevated view of substrate 100 having ink droplets 166 deposited thereon. The scanning laser beam 162 is directed such that the laser spot 176 affects only the area of deposited droplet 166. Ink droplets 166 may absorb the curing radiation energy provided by laser spot 176. This energy may initiate the ink-curing process. The ink curing radiation energy does not affect the blank ink-free areas of substrate 100 as it aimed only onto droplets 166. Therefore, substrate 100 does not change its dimensions during the curing process.

The curing radiation may be infrared radiation. Alternatively the curing radiation may be blue light radiation or ultraviolet radiation provided that suitable ink is used in the printing process. According to other embodiments of the present invention, the curing energy may be microwave radiation, which affects primarily the ink and not the substrate.

According to some other exemplary embodiments of the present invention, the curing radiation may be delivered by a plurality of laser sources. The number of laser sources may be the same as the number of nozzles of the print head. A non-limiting example of such an arrangement may comprise individual pigtailed laser diodes having fiber tips arranged in a V-groove. Alternatively, individually addressable laser diode arrays (IALDA) may be used.

The laser source may deliver pulses or bursts of ink curing laser radiation. The time during which the laser source delivers the curing radiation may be larger, smaller or equal to the time between two successive ink ejection cycles. In agreement with this exemplary embodiment, the laser source may deliver bursts or flashes of ink curing laser radiation where the time between the successive bursts of curing laser radiation is substantially smaller than the time between two successive ink ejection cycles. In this case each ink droplet may be cured by a plurality of ink curing laser radiation bursts or flashes.

The amount of energy delivered in each of the ink curing laser radiation delivery modes may be different. Each successive burst of curing laser radiation may optionally deliver different amount of ink curing laser radiation. For example the curing energy required for the curing of Yellow ink may be, depending on particular ink formulation, higher than the one required for the curing of the Black ink. Larger amount of energy may be provided in this case for the curing of the black ink. Both pulse duration and laser diode operating power level provide convenient tools for regulation to the amount of ink curing radiation energy.

The method as described above provides advantages over the prior art in that the ink curing laser radiation is delivered only to the inked sections of the substrate. The amount of energy delivered to each of the substrate sections is different, defined by the image content of the particular substrate section and creates optimal ink curing conditions for this image section. Furthermore, when the curing energy is delivered in short pulses, the heating of the substrate may be significantly reduced and subsequently the warping of the substrate may be avoided.

According to exemplary embodiments of the present invention, the mage-content dependent ink curing method allows building of a printer caring out the ink curing method of the present invention smaller than UV curing or IR drying machines. The ink curing laser radiation sources are preferably laser diodes. Such laser diodes are preferably solid-state devices providing thousands of operating hours, as compared to few hundred hours for UV or IR lamps. The maintenance cost of laser diodes is substantially lower that the maintenance cost of UV curing or IR drying lamps and as a result of it the equipment cost is reduced.

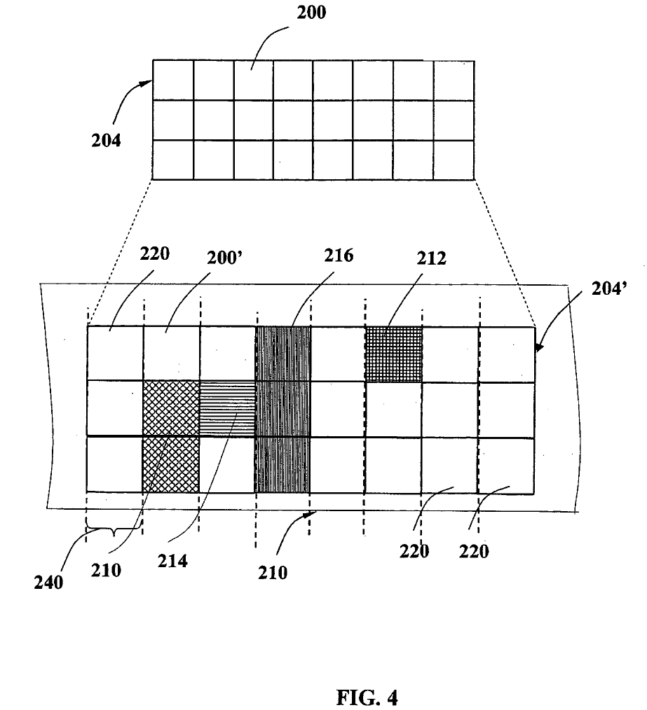

Image content dependent ink curing method does not preclude the use of conventional UV lamps for ink curing. FIG. 4 shows a UV-lamp arrangement constructed in accordance with exemplary embodiments of the present invention. Relatively small size UV lamps, such as TILL UV flash lamp commercially available from Applied Scientific Instrumentation, Inc., Eugene, Oreg., USA. Or Xenon flash lamps, such as L7684 commercially available from Hamamatsu Photonics K.K., Hamamatsu City, Japan. Lamps 200 are arranged in two or three or more rows, as it may be required for proper energy delivery to substrate 100. Lamps 200 form an UV illuminating matrix 204.

Numeral 204′ marks projection of UV illuminating matrix 204 onto printed media 100. Each square 200′ designates an image section and corresponds respectively to a flash UV lamp 200. The number of flashes each square 200′ gets is proportional to “image content” of the particular square. Number of flashes, their amplitude, flash frequency and the number of flash lamps operated over particular square provide the required amount of ink curing radiation. For example, a portion of the image as illustrated by square 214 that has ink coverage of 60% may get less ink curing radiation energy than squares 216 or 212 that have ink coverage of 125% and 160% respectively. Square 210 has ink coverage of 110% and will get less ink curing radiation energy than squares 216 or 212 but more than square 214. Squares 220 that do not contain any image will not get ink curing radiation energy at all.

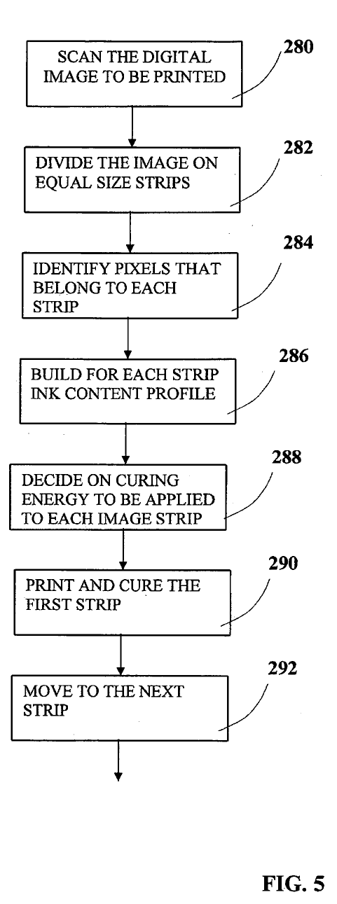

In accordance with this exemplary “image dependent” curing embodiment and in order to establish the required curing energy for each image section 200′ prior to printing the information describing the image to be printed is preprocessed as shown in FIG. 5. The image to be printed is scanned in a digital form (block 280) and is divided into strips 240. Each strip may be divided to several squares (block 282). The width of each strip 240 (FIG. 6) is equal to the width 200′ illuminated by each of lamps 200. A controller or a RIP software identifies all the pixels forming the belonging to a particular strip 240 (block 284) and builds an ink content profile along each of the strips (block 286). This ink content profile or simply amount of ink in each particular strip 240 drives the information representing the illumination field of each of the lamps illuminating the particular strip and forming the lamp matrix. The controller defines optimal curing energy to be applied for curing the ink of each of strips 240 (block 288). Printing of the first image strip is performed and the strip is cured by appropriate lamp 200 (block 290). The flash energy provided by each of the lamps corresponds to the image content of the particular illumination field of the lamp. The energy provided to each of the illumination fields may be regulated by the duration of the flash and the frequency of the subsequent flashes provided by each of the lamps 200 forming the illumination matrix. The printing process continues to the next strip 240 (Block 292). The printing process continues until the entire image is printed and cured.

Use of a UV curing light source presenting a matrix of smaller UV lamps operated in a image content dependent curing mode may be operated by a combination of a number of sources including fixed level source for e.g. 20% or 40% as required by particular section image content that will play the role of an offset or bias for the flash operated UV light source. A number of synchronized flash sources may also be operated. The required curing energy may be distributed between the sources to provide optimal curing results. This mode of operation is an advantage over the existing UV curing methods.

Exemplary Compositions of Infrared Curable Ink

Some embodiments of the present invention are directed to various compositions of infrared-curable ink-jet recording fluids. According to some embodiments of the present invention, the ink composition comprises acrylates that are capable of undergoing polymerization reaction under infrared radiation and infrared-activated initiators.

The relative amounts of the different components of the ink-jet recording fluid may vary. For example, the relative amount of the infrared-activated initiator may vary between 0.1 weight percentage and 7 weight percentage.

According to some embodiments of the present invention, the relative amount of the infrared-activated initiator may be 0.1 wt %-1 wt %. According to some embodiments of the present invention, the relative amount of the infrared-activated initiator may be 1 wt %-2 wt %. According to some embodiments of the present invention, the relative amount of the infrared-activated initiator may be 2 wt %-3 wt %. According to some embodiments of the present invention, the relative amount of the infrared-activated initiator may be 3 wt %-4 wt %. According to some embodiments of the present invention, the relative amount of the infrared-activated initiator may be 4 wt %-5 wt %. According to some embodiments of the present invention, the relative amount of the infrared-activated initiator may be 5 wt %-6 wt %. According to some embodiments of the present invention, the relative amount of the infrared-activated initiator may be 6 wt %-7 wt %.

The composition may further any coloring agent, such as for example pigment and/or dye, and optionally surfactants such as wetting agents, leveling agents and the like. Non-limiting examples of pigments that may be used in the formulations of exemplary embodiments of the present invention may be Permajet Blue B2G, Microlith Black CK, Permajet Yellow, Microlith Red 5C-K or mixture of several pigments.

Additionally, the composition may comprise additives, such as for example preservatives, anti-molds and the like to enhance storage and shelf stability.

Any suitable acrylates may be used. Although the scope of present invention is not limited in this respect, the acrylate may be Trimethylolpropane-triacrylate, Hexanedioldiacrylate, and Tetrahydrofurfuryl acrylate.

In the following examples of ink compositions, component designations are in weight percentages or volume percentage as indicated. It is noted that the following examples do not limit in any way the scope of the present invention. Formulation A is an exemplary ink formulation that does not contain a heat-activated initiator (thermal initiator).

Formulation A

| Ingredient | Percentage by Weight |
|---|---|
| Trimethylolpropane-triacrylate | 5% |
| Aminoacrylate (CN - 383) | 4% |
| BYK-163 (surfactant and | 0.5% |
| dispersant) | |
| Pigment | 3% |
| Hexanedioldiacrylate | 87.5% |

According to exemplary embodiments of the present invention, the ink formulations may comprise infrared or heat activated initiators:

Formulations B-F are examples of ink formulations comprising infrared activated initiators, which were added to Formulation A, presented above.

Formulation B

| Ingredient | Percentage by Volume |
|---|---|
| Lauroyl peroxide | 0.1%-2% |
| Formulation A | 98%-99% |

Formulation B was coated on (12 micron thickness) an aluminum foil. The ink was heated at 100° C. Although the ink was dried, the dried ink layer had a wrinkled surface. Formulation B exhibited sensitivity to environmental conditions and tended to polymerize after 15 minutes to 30 minutes at room temperature. Formulation B was tested with Magenta and Cyan pigments. Inks containing black pigment tended to polymerize at a faster rate.

Formulation C

| Ingredient | Percentage by Volume |
|---|---|
| Dicumyl peroxide | 0.51%-5% |
| Formulation A | 95%-99% |

Formulation C was coated on (12 micron thickness) an aluminum foil. The ink was heated at 130° C. Full ink curing was reached; gloss and density remained stable for a long period. Ink produced in accordance with formulation C remained stable and good for use after storage for two weeks at a temperature of 40° C. No changes in the ink viscosity were observed.

Formulation D

| Ingredient | Percentage by Volume |
|---|---|
| Pentanedione-peroxide | 1%-2% |
| Formulation A | 98%-99% |

Formulation E

| Ingredient | Percentage by Volume |
|---|---|
| Tert-amyl peroxy-benzoate (with | 1%-2% |
| Cyan pigment) | |
| Formulation A | 98%-99% |

Formulation F

| | Percentage by |
|---|---|
| Ingredient | Volume |
| 1,1′-Azobis-cyclohexane | 1%-2% |
| carbonitryle. | |
| Formulation A | 98%-99% |

Formulations D, E, and F were coated on (12 micron thickness) an aluminum foil and were cured by IR radiation at wavelength of 808 nanometer. The curing energy applied to the ink on the substrate was of about 0.1J to 1.0J. Full ink curing was reached; gloss and density remained stable for a long period. Inks produced in accordance with these formulations remained stable and good for use after storage at different storage conditions.

In general, it was also found that the curing rate may be regulated by addition of some materials. For example, addition of 1% of quaternary ammonium salt (surfactant from Aliquat® series) may increase the curing rate. In general, the ink formulations are not limited to formulations using conventional thermal initiators.

Several ink formulations were coated on a vinyl substrate. Selected sections of coated substrates were exposed to concentrated radiation and specifically IR radiation by IR lasers. Exposures were made at wavelengths of 808 nm and 980 nm. Spot sizes were respectively 5 mm and 2 mm in diameter. Curing at wavelength of 808 nm was faster and required about 60% lower energy levels than at wavelength of 980 nm. Black ink cured at energy levels significantly lower than other inks and especially yellow ink. Yellow ink required curing energy of nearly an order of magnitude higher than black ink. Addition of proper laser wavelength absorbers may be used to regulate the energy levels required for proper ink curing.

The process described above illustrates localized curing by an infrared laser according to embodiments of the present inventions. The cured ink layer did not change its thickness, and it could not be removed by solvents such as acetone, MEK or alcohol, and was abrasion resistant.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An infrared curable ink composition for ink-jet recording comprising:
an acrylate able to undergo polymerization reaction under infrared radiation;
an infrared activated initiator; and
a coloring agent.

2. The composition of claim 1 wherein said coloring agent is a pigment.

3. The composition of claim 1, wherein said infrared activated initiator is lauroyl peroxide, dicumyl peroxide, pentanedione-peroxide, tert-amyl peroxy-benzoate, 1,1′-azobis-cyclohexane carbonitryle or any combination thereof.

4. The composition of claim 1, wherein the concentration of said infrared activated initiator is 0.2-7% by weight.

5. The composition of claim 1, wherein said acrylate is hexanedioldiacrylate.
